(19) United States
(12) Patent Application Publication
(10) Pub. No.: US 2024/0058873 A1
(43) Pub. Date: Feb. 22, 2024

(54) GANTRY DRILL

(71) Applicant: Cascade Lumber Company, Cascade, IA (US)

(72) Inventors: Timothy M. NOONAN, Cascade, IA (US); Scott G. WAGNER, Cascade, IA (US)

(21) Appl. No.: 17/975,987

(22) Filed: Oct. 28, 2022

Related U.S. Application Data
(60) Provisional application No. 63/398,953, filed on Aug. 18, 2022.

(51) Int. Cl. B23B 39/14; B23Q 3/18

(52) U.S. Cl. CPC B23B 39/14; B23Q 3/18

(57) ABSTRACT

A carriage combined to a floor-mounted track for movement along the track in the longitudinal direction; a lateral track combined to the carriage and extending above and perpendicular to the floor-mounted track; a platform combined to the lateral track for lateral movement along the lateral track; and a vertical frame combined to the platform configured for movement with respect to the platform along a z-axis, wherein the vertical frame is configured to receive a commercial-off-the-shelf drill to attach fasteners in a work-piece in the z-axis.

### PRIORITY CLAIM

This non-provisional application claims the benefit of and priority to U.S. Provisional Patent Application No. 63/398,953 filed on Aug. 18, 2022, the entire contents of which are hereby incorporated by reference herein.

### TECHNICAL FIELD

This invention relates generally to a gantry drill, and, more specifically, this invention relates to a 3-axis track-mounted gantry drill for manufacturing steel trusses.

### BACKGROUND INFORMATION

The construction of cold-formed steel (CFS) trusses are complex and costly. Generally, such process includes manual placement of the self-tapping, self-drilling screws in cold-formed steel. It is widely recognized that such process is extremely costly and labor intensive due to the high quantity of fastener holes drilled into heavy gauge steel. It is not uncommon to place hundreds fasteners in a truss.

Accordingly, there is a need for an improved construction method for long work pieces, such as cold-formed steel trusses.

### SUMMARY

In accordance with one aspect of the present invention, disclosed is a gantry drill comprising: a floor-mounted track extending in a longitudinal direction; a carriage combined to the floor-mounted track for movement along the track in the longitudinal direction; a lateral track combined to the carriage and extending above and perpendicular to the floor-mounted track; a platform combined to the lateral track for lateral movement along the lateral track; and a vertical frame combined to the platform configured for movement with respect to the platform along a z-axis, wherein the vertical frame is configured to receive a commercial-off-the-shelf drill to attach fasteners in a work-piece in the z-axis.

In one embodiment, the gantry drill comprises of a floor-mounted track with a guide and an angle-channel. The carriage comprises of a roller and a locking-roller. The roller of the carriage is positioned on the guide and the locking-roller of the carriage is positioned in the angle-channel, so that the roller of the carriage moves along the guide and the locking-roller prevents the carriage from lifting with respect to the floor-mounted track. The carriage can comprise of a frame with a seat attached to the frame for movement with the carriage along the track in the longitudinal direction.

In an embodiment, a linear track can be provided above and perpendicular to the lateral track. A vertical frame is combined to the linear track for movement along the linear track and between the lateral track. An actuator is combined to the vertical frame with a rod movable with respect to the actuator. A vertical sub-frame is combined to the rod of the actuator for movement along the z-axis with respect to the vertical frame. The vertical sub-frame comprises of a bottom plate with a hole for receiving a chuck of a commercial-off-the-shelf drill to hold a rotational axis of the commercial-off-the-shelf drill on the z-axis. A lock is positioned above the bottom plate and positionable across a handle of the commercial-off-the-shelf drill to lock the commercial-off-the-shelf drill from movement in the z-axis.

In an embodiment, an extending member is combined to the vertical frame and extends downward. A handle is combined to the extending member for manual manipulation of the vertical frame along the lateral track and along the linear track. A trigger is positioned near the handle and combined to the actuator to initiate movement of the rod of the actuator to move the vertical sub-frame along the z-axis with respect to the vertical frame. A lock-button can be provided near the handle to lock movement of the platform with respect to the lateral track. A brake cylinder can be combined to the platform for selective engagement with the lateral track to lock the platform from movement in a lateral direction.

### BRIEF DESCRIPTION OF THE DRAWINGS

These and other features and advantages of the present invention will be better understood by reading the following detailed description, taken together with the drawings wherein:

FIG. 1 is a perspective view of a gantry drill according to this disclosure.

FIG. 2 is close-up view of the longitudinal track for the gantry drill of FIG. 1.

FIG. 3 is a close-up view of the gantry drill of FIG. 1.

FIG. 4 is a close-up view of the gantry drill of FIG. 1 with one of the lateral tracks removed for clarity.

FIG. 5 is a close-up view of the drill of the gantry drill of FIG. 1.

### DETAILED DESCRIPTION OF THE PREFERRED EMBODIMENTS

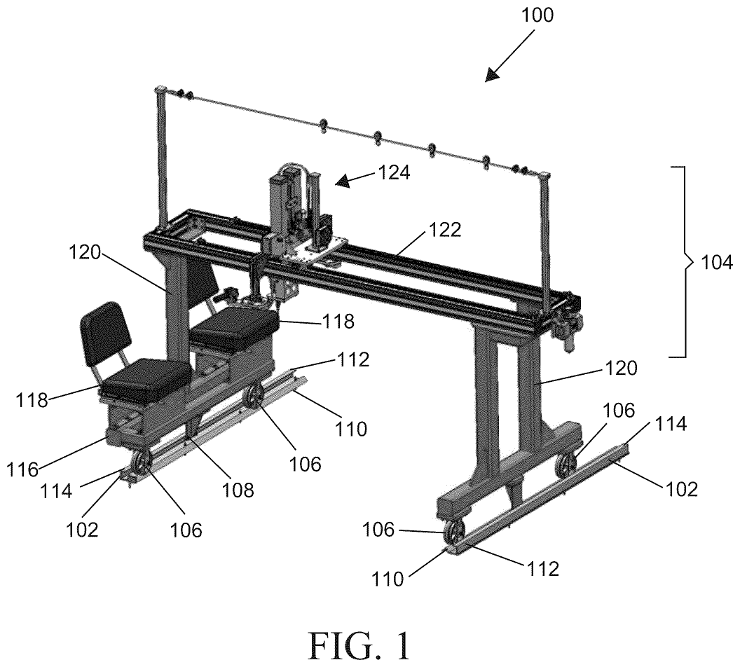

Referring to FIG. 1, shown is a gantry drill 100 according to this disclosure. Gantry drill 100 is designed for construction of cold-formed steel trusses. These trusses can span 40 yards or more in length and require hundreds of fasteners to construct. To reduce fatigue and improve placement accuracy of the fasteners, gantry drill 100 comprises of a longitudinal track 102 fixed to a shop floor and a movable carriage 104 that glides along longitudinal track 102 the length of the truss. From a seated position, an operator can easily and accurately place the fasteners in the truss.

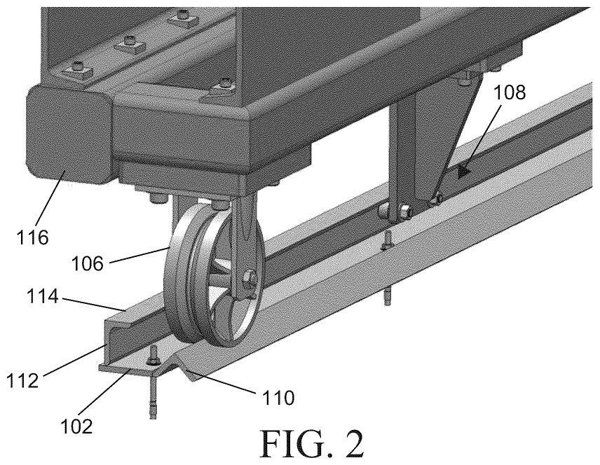

More specifically, turning to FIG. 2, carriage 104 comprises of rollers 106 and at least one locking roller 108 that are engaged with longitudinal track 102 to allow carriage to easily glide up and down longitudinal track 102. Longitudinal track 102 can comprise a steel guide 110 in an inverted-v configuration to provide a cooperating shape for rollers 106. An angle channel 112 shaped like a seven with an upper ledge 114 is designed to receive locking roller(s) 108 such that upper ledge 114 prevents locking roller(s) 108 from lifting vertically, upward. Because locking roller 108 is attached to a frame 116 of carriage 104, carriage 104 is secured, vertically to longitudinal track 102 to prevent carriage 104 from lifting when fasteners are being drilled into the truss.

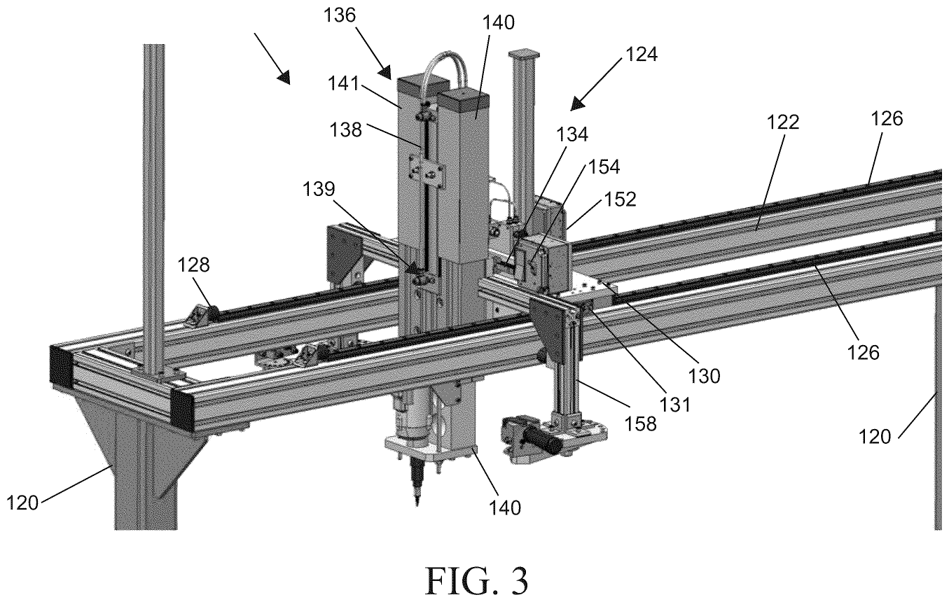

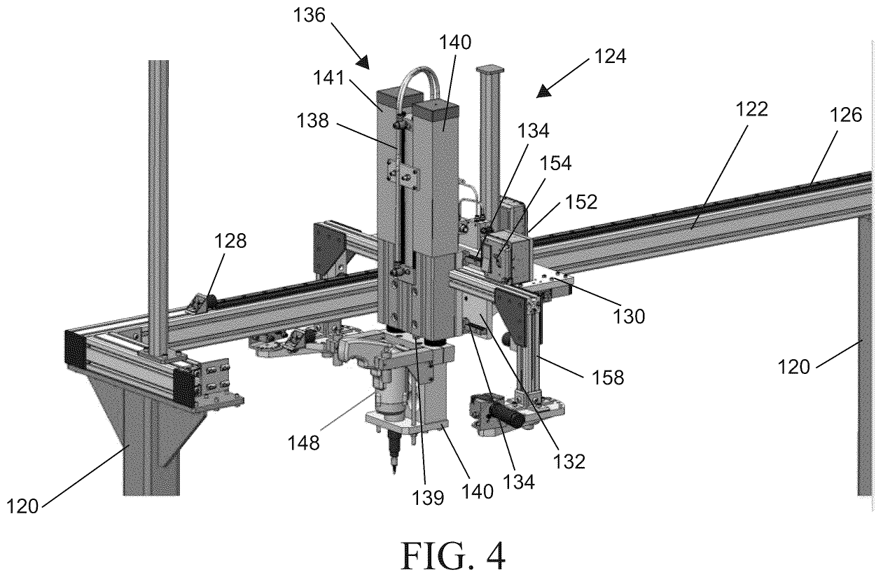

Returning to FIG. 1, attached to frame 116 of carriage 104 can be one or more seats 118 to provide the operator with a comfortable sitting position. While the illustrated embodiment shows two seats 118 on the same side, one can easily envision a seat on the opposite side for an operator to work either simultaneous or for coming down the truss on the opposite side. Extending upward from frame 116 are support members 120 for a lateral track 122 that extends laterally across rail-to-rail of longitudinal track 102. A drill carriage 124 is slidingly engaged with lateral track 122, which is shown in greater detail in FIGS. 3 and 4, with and without one lateral track 122 removed for clarity.

Lateral track 122 can comprise two aluminum rails that extend above and perpendicular to longitudinal track 102. Each lateral track 122 can further comprise a linear bearing 126, so that drill carriage 124 glides across lateral track 122 more smoothly. A stop 128 can also be positioned at each end of linear bearing 126 to arrest the travel of drill carriage 124 at opposite ends.

Drill carriage 124 is configured to set upon linear bearings 126 of lateral track 122. A platform 130 is provided with the bottom side of which set upon linear bearings 126. Platform 130 can provide a support structure for holding various elements. A brake cylinder 131 can be attached to platform 130 positioned to selectively engage linear bearing 126 to lock drill carriage 124 in place in the lateral direction for accurate placement of fasteners linearly along the longitudinal direction of the truss.

A plate 132 is attached perpendicular to platform 130 with a pair of linear tracks 134 attached thereto, which can be implemented as linear bearings. Linear tracks 134 extend in the longitudinal direction parallel with the direction of longitudinal rails 102 and perpendicular to the direction of lateral track 122.

Slidingly attached to linear tracks 134 is a vertical frame 136, which is configured for side-to-side movement between each lateral track 122. This arrangement allows drill carriage 124 to be moved into an approximate position with respect to the truss on longitudinal track 102 and then finely adjusted in the appropriate longitudinal direction by the operator.

Vertical frame 136 comprises of an actuator 138 oriented perpendicular to both lateral track 122 and linear tracks 134 in the direction of the z-axis. A protective member 141 can be positioned on opposite sides of actuator 138 for support and protection. A rod 139 extending from actuator 138 is connected to a vertical sub-frame 140 for movement by rod 139 along the z-axis.

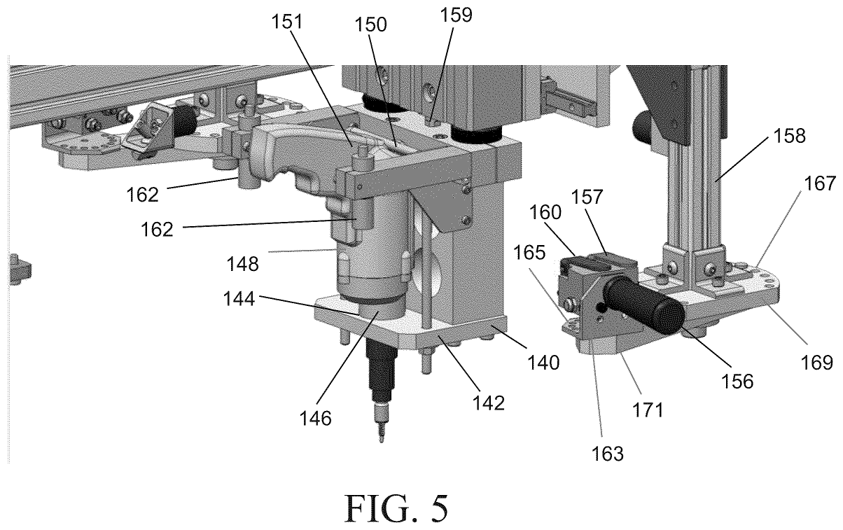

Turning to FIG. 4 and FIG. 5, vertical sub-frame 140 is shown more clearly. Vertical sub-frame 140 comprises of a bottom plate 142 with a hole 144 for receiving a chuck 146 of a commercial-off-the-shelf drill 148 to hold a rotational axis of commercial-off-the-shelf drill 148 on the z-axis. A lock 150 is positioned above bottom plate 142 and positionable across a handle 151 of drill 148 to lock drill 148 from movement in the z-axis. Lock 150 can simply be a bar that extends across vertical sub-frame 140 such that it can be removed, tilted, or moved out of the way to install and lock drill 148 into vertical sub-frame 140.

This arrangement allows any commercial-off-the-shelf drill 148 to be simply installed and replaced when it wears out. Drill 148 can be cordless or battery powered. In the cordless embodiment, the power cable can be routed up to a junction box 152 on platform 130 where it is connected to line power by a switch 154 so that the operator simply flips switch 154 to turn on/off drill 148. A handle 156 and a button 157 can be positioned on an extending member 158 that extends out and down from vertical frame 136 so that it is oriented towards seat 118. Handle 156 and button 157 and another button 160 (discussed below) can be attached to an angle plate 163 that is attached to a plate 171. This angle plate 163 has a plurality of alignment holes 165 that cooperate with a plurality of alignment holes 167 on a plate 169. A pin is positioned in one of the plurality of alignment holes 165 and one of the plurality of alignment holes 167 to fix plate 171 relative to plate 169. This means that plate 171 with handle 156 can be positioned at an angle that is convenient to the operator and rotated 180 degrees to be on the opposite side.

With a simple press of button 157, drill 148 can be moved up and down by actuator 138. Actuator 138 can be a pneumatic cylinder that be adjusted in pressure according to the material thickness of the work piece. A separate button 160 on handle 156 can lock drill carriage 124 in place on lateral track 122, as described above, by engaging brake cylinder 131 to prevent drill carriage 124 from moving laterally during use to allow screws to be placed in a straight line in the longitudinal direction if needed. Button 160 is combined in a pneumatic circuit to brake cylinder 131.

The underside of bottom plate 142 of vertical sub-frame 140 has positioned thereon two lasers 162 to provide crosshairs aligned with the z-axis of drill 148 to provide the user with a target area for the screw tip on the work piece. This is invaluable as it increases efficiency and reduces errors that require rework or extra screws. Drill 148 and lasers 162 can each have their own on/off switches mounted on platform 130.

Drill carriage 124 is configured for 3-axis movement of drill 148 along the x, y, and z axes where longitudinal rails 102 extend along an x-axis, lateral tracks 122 extend along the y-axis, and the actuator moves vertical sub-frame with drill 148 along the z-axis. Along the x-axis longitudinal rails 102 provide a gross movement of carriage 104 while vertical frame 136 attached to linear tracks 134 on platform 130 provide fine positioning control of drill carriage 124. This means that drill 148 can travel the length of the truss to reach the top and bottom chords while being able to travel 4 inches inside the lateral tracks 122 to allow a user to move drill carriage 124 in smaller areas without having to move the entire carriage 104.

Those skilled in the art will recognize that the pneumatic circuit used for actuator 138 and brake cylinder 131 can be implemented with hydraulic or electric actuators and cylinders of the same. Those also so skilled will recognize that the foregoing gantry drill can be used with any type of long work piece, including trusses.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

We claim:

1. A gantry drill comprising:
a floor-mounted track extending in a longitudinal direction;
a carriage combined to the floor-mounted track for movement along the track in the longitudinal direction;
a lateral track combined to the carriage and extending above and perpendicular to the floor-mounted track;
a platform combined to the lateral track for lateral movement along the lateral track; and
a vertical frame combined to the platform configured for movement with respect to the platform along a z-axis, wherein the vertical frame is configured to receive a commercial-off-the-shelf drill to attach fasteners in a work-piece in the z-axis.

2. The gantry drill of claim 1, wherein the floor-mounted track comprises of a guide and an angle-channel; wherein the carriage comprises of a roller and a locking-roller; and wherein the roller of the carriage is positioned on the guide and the locking-roller of the carriage is positioned in the angle-channel so that the roller of the carriage moves along the guide and the locking-roller prevents the carriage from lifting with respect to the floor-mounted track.

3. The gantry drill of claim 2, wherein the carriage comprises a frame with a seat attached to the frame for movement with the carriage along the track in the longitudinal direction.

4. The gantry drill of claim 1, and further comprising a linear track positioned above and perpendicular to the lateral track, wherein the vertical frame is combined to the linear track for movement along the linear track and between the lateral track.

5. The gantry drill of claim 4, and further comprising an extending member combined to the vertical frame and extending downward; and a handle combined to the extending member for manual manipulation of the vertical frame along the lateral track and along the linear track.

6. The gantry drill of claim 4, and further comprising an actuator combined to the vertical frame with a rod movable with respect to the actuator; and a vertical sub-frame combined to the rod of the actuator for movement along the z-axis with respect to the vertical frame.

7. The gantry drill of claim 6, and further comprising: a handle combined to the vertical frame for manual manipulation of the vertical frame along the lateral track and the linear track; and a trigger positioned near the handle and combined to the actuator to initiate movement of the rod of the actuator to move the vertical sub-frame along the z-axis with respect to the vertical frame.

8. The gantry drill of claim 7, and further comprising a lock-button positioned near the handle to lock movement of the platform with respect to the lateral track.

9. The gantry drill of claim 1, wherein the vertical frame comprises a vertical sub-frame configured for movement with respect to the vertical frame along the z-axis, and wherein the vertical sub-frame further comprises of a bottom plate with a hole for receiving a chuck of the commercial-off-the-shelf drill to hold a rotational axis of the commercial-off-the-shelf drill on the z-axis.

10. The gantry drill of claim 9, and further comprising a lock positioned above the bottom plate and positionable across a handle of the commercial-off-the-shelf drill to lock the commercial-off-the-shelf drill from movement in the z-axis.

11. The gantry drill of claim 1, and further comprising a brake cylinder combined to the platform for selective engagement with the lateral track to lock the platform from movement in a lateral direction.

12. A gantry drill for movement on a floor-mounted track configured to receive a commercial-off-the-shelf drill, the gantry drill comprising:
a carriage combined to the floor-mounted track for movement along the track in a longitudinal direction;
a lateral track combined to the carriage and extending above and perpendicular to the floor-mounted track;
a platform combined to the lateral track for lateral movement along the lateral track; and
a vertical frame combined to the platform configured for movement with respect to the platform along a z-axis, wherein the vertical frame is configured to receive a commercial-off-the-shelf drill to attach fasteners in a work-piece in the z-axis.

13. The gantry drill of claim 12, wherein the carriage comprises of a roller and a locking-roller so that the roller of the carriage moves along a guide of a floor-mounted track and the locking-roller prevents the carriage from lifting with respect to the floor-mounted track.

14. The gantry drill of claim 13, wherein the carriage comprises a frame with a seat attached to the frame for movement with the carriage along the floor-mounted track in the longitudinal direction.

15. The gantry drill of claim 14, and further comprising a linear track combined to the platform and positioned above and perpendicular to the lateral track, wherein the vertical frame is combined to the linear track for movement along the linear track with respect to the platform between the lateral track.

16. The gantry drill of claim 15, and further comprising an actuator combined to the vertical frame with a rod movable with respect to the actuator; and a vertical sub-frame combined to the rod of the actuator for movement along the z-axis with respect to the vertical frame; wherein the vertical sub-frame further comprises of a bottom plate with a hole for receiving a chuck of the commercial-off-the-shelf drill to hold a rotational axis of the commercial-off-the-shelf drill on the z-axis.

17. The gantry drill of claim 16, and further comprising: a handle combined to the vertical frame for manual manipulation of the vertical frame along the lateral track and the linear track; and a trigger positioned near the handle and combined to the actuator to initiate movement of the rod of the actuator to move the vertical sub-frame along the z-axis with respect to the vertical frame.

18. The gantry drill of claim 17, and further comprising a lock-button positioned near the handle to lock movement of the platform with respect to the lateral track.

19. The gantry drill of claim 18, and further comprising a brake cylinder combined to the platform for selective engagement with the lateral track to lock the platform from movement in a lateral direction.

20. The gantry drill of claim 16, and further comprising an angle plate for attaching the handle thereto with the angle plate being combined to a first plate where the angle plate has a plurality of holes oriented in the z-axis; a second plate with a plurality of holes oriented in the z-axis, wherein the first plate can be rotated with respect to the second plate; and a pin for combining the first plate to the second plate to fix the orientation of the two.
